(19) United States
(12) Patent Application Publication
(10) Pub. No.: US 2018/0126609 A1
(43) Pub. Date: May 10, 2018

(54) RESIN COMPOSITE MATERIAL, CURING METHOD THEREOF, AND MOLDED RESIN ARTICLE

(71) Applicant: MITSUBISHI HEAVY INDUSTRIES, LTD., Tokyo (JP)

(72) Inventors: Nobuyuki KAMIHARA, Tokyo (JP); Toshio ABE, Tokyo (JP)

(73) Assignee: MITSUBISHI HEAVY INDUSTRIES, LTD., Tokyo (JP)

(21) Appl. No.: 15/561,112

(22) PCT Filed: May 23, 2016
(86) PCT No.: PCT/JP2016/065139

§ 371 Date: Sep. 25, 2017

(30) Foreign Application Priority Data
Jun. 3, 2015 (JP) 2015-113322

(51) Int. Cl. B29C 43/52; C08J 5/04; B29C 35/08

(52) U.S. Cl. CPC B29C 43/52; C08J 5/041; B29C 2035/0861; C08J 2300/22; C08J 2300/24; B29C 35/0805

(57) ABSTRACT

In order to simplify the equipment for heating a thermosetting resin or a thermoplastic resin and to reduce manufacturing costs of a molded resin article by saving energy, this resin composite material (1A-1I) is formed by combining a fibrous reinforcing material (2) and a thermosetting or thermoplastic matrix resin (3), wherein a metal nanomaterial (4) which self-heats after absorbing electromagnetic waves is added to the matrix resin (3). The frequency of the electromagnetic waves is preferably within the range of 3 MHz to 3 GHz. The metal nanomaterial (4) is preferably nanofibers or nanocoils, and the material is preferably platinum or gold.

### TECHNICAL FIELD

The present invention relates to a resin composite material, a curing method thereof, and a molded resin article.

### BACKGROUND ART

A reinforced resin composite material (fiber reinforced plastic) obtained by impregnating a fibrous reinforcing material such as glass fibers or carbon fibers into a matrix resin is a lightweight material having high strength and high elasticity and is widely used in an aerospace industry, an automobile industry, sports equipment, or the like.

As the matrix resin of the resin composite material, a thermosetting resin or a thermoplastic resin is suitably used since the resins have a short curing time and high productivity. In recent years, an intermediate molding material is frequently used, which is referred to as a flexible prepreg which is semi-cured by impregnating a thermosetting or thermoplastic matrix resin to a mat-shaped fibrous reinforcing material.

In general, as described in PTL 1, in a case where a resin molded article is molded by a prepreg, the prepreg is laminated or wound on a molding tool, a jig, or the like of a manufactured molded resin article to be molded into a predetermined shape, and the prepreg is enclosed by a vacuum bag so as to be evacuated in order to increase adhesion with respect to the molding tool, the jig, or the like. Thereafter, the prepreg is accommodated in a heater such as an autoclave, and the matrix resin of the prepreg is cured while being heated, pressurized, and degassed.

PTL 2 discloses an adhesive agent which bonds two adherends in which at least one of the two adherends is formed of a resin material, and the adhesive agent contains microwave absorbing substances configured carbon black or SiC. The adhesive agent is self-heated by irradiating the adhesive agent with microwaves after the bonding, and the adhesive agent is cured by the heat. Accordingly, the adhesive agent may be used as a matrix resin in the resin composite material.

### CITATION LIST

### Patent Literature

[PTL 1] Japanese Unexamined Patent Application Publication No. 2011-152753

[PTL 2] Japanese Unexamined Patent Application Publication No. 2008-156510

### SUMMARY OF INVENTION

### Technical Problem

In PTL 1, in a case where the resin composite material such as the prepreg is heated along with a molding tool, a jig, a vacuum bag, or the like by a heater such as an autoclave, a plurality of heaters are required to be prepared according to the size or the shape of a molded resin article to be molded, and the manufacturing costs of the molded resin article increase.

In addition, when the resin composite material is heated by the heater, it is not possible to increase the temperature of the resin composite material if not only the resin composite material but also all portions including the molding tool, the jig, or the like are not heated. Accordingly, a heating process takes a long period of time, and energy consumed for the heating is excessive.

In PTL 2, even when the microwave absorbing substances formed of carbon black or SiC is contained in the matrix resin in the resin composite material, a self heating value of the carbon black or SiC when irradiated with microwaves is at most approximately 70° C. to 100° C., it is not sufficient to increase the temperature of the entire resin composite material along with the temperature of the molding tool, the jig, or the like, which is not practical. Moreover, since the carbon black or SiC has low heat-generation properties, a mixing amount thereof to a resin is relatively large. Accordingly, the mixing amount of materials different from each other increases, and there is a concern that strength of the matrix resin and strength of the resin composite material decrease.

The present invention is made in consideration of the above-described circumstances, and an object thereof is to provide a resin composite material, a curing method thereof, and a molded resin article capable of simplifying equipment for heating a thermosetting resin or a thermoplastic resin and reducing manufacturing costs of the molded resin article by saving energy.

### Solution to Problem

In order to achieve the object, the present invention adopts the following means.

According to a first aspect of the present invention, there is provided a resin composite material formed by combining a fibrous reinforcing material and a thermosetting or thermoplastic matrix resin, in which a metal nanomaterial which absorbs electromagnetic waves and self-heats is added to the matrix resin.

If the resin composite material is irradiated with the electromagnetic waves, metal nanomaterial added to the matrix resin absorbs the electromagnetic waves and self-heats. This heat is transmitted to the matrix resin to heat the resin and the matrix resin which is a thermosetting or thermoplastic resin is softened.

In a case where the matrix resin is a thermosetting resin, a curing reaction is generated by pressurization in this state, and the resin composite material is cured. Meanwhile, in a case where the matrix resin of the resin composite material is a thermoplastic resin, the resin composite material is cured by cooling the thermoplastic resin.

Accordingly, unlike the related art, it is not necessary to accommodate the resin composite material to be cured in a storage type heater such as an autoclave and the storage type heater is not required. Therefore, it is possible to greatly simplify the heating equipment and reduce the manufacturing costs of a molded resin article.

In addition, since only the matrix resin is heated by the irradiation of the electromagnetic waves, unlike a case where the heater of the related art is used, energy for heating all portions including the molding tool, the jig, or the like is not required. Accordingly, it is possible to save energy. Therefore, it is possible to reduce the manufacturing costs of the molded resin article.

In addition, since it is possible to locally heat the resin composite material by limiting irradiation ranges of the electromagnetic waves, an addition can be provided or additional molding or additional processing can be performed by locally heating the molded resin article again after curing the entire molded resin article.

In the first aspect, preferably, the metal nanomaterial is nanofibers or nanocoils. According to the metal nanomaterial having the shape, since the metal nanomaterial is formed in thin metal wire shapes which are oriented in many directions, particularly, the electromagnetic wave absorption efficiency becomes high. Accordingly, it is possible to rapidly increase the temperature of the matrix resin.

In addition, since it is possible to decrease an addition amount of the metal nanomaterial, it is possible to decrease occurrence of cracks in the matrix resin and prevent strength of the resin composite material from being decreased.

In the first aspect, preferably, frequencies of the electromagnetic waves are 3 MHz to 3 GHz. In the metal nanomaterial of the present aspect, absorption efficiency of the electromagnetic waves having the frequencies is high. In addition, since the frequency range is an electromagnetic wave frequency band which does not require a special management, it is possible to emit the electromagnetic waves by a simple device.

In the first aspect, preferably, the material of the metal nanomaterial is platinum or gold. Accordingly, even when a manufacturing process of the metal nanomaterial is performed under an oxidizing atmosphere, the platinum or the gold is not easily oxidized. In addition, even when the platinum or the gold is oxidized, the oxide has conductivity. Accordingly, it is possible to manufacture the metal nanomaterial having high electromagnetic wave absorption efficiency.

In the first aspect, preferably, an addition amount of the metal nanomaterial with respect to the matrix resin is 2 μg/cm² to 50 μg/cm² in terms of a weight ratio per unit area. By setting the addition amount of the metal nanomaterial to the range, self-heating properties sufficient for performing the heat curing are applied to the matrix resin, it is possible to prevent occurrence of cracks or the like generated due to the excessive addition amount of the metal nanomaterial, and it is possible to prevent strength of the resin composite material from being decreased.

In the first aspect, the fibrous reinforcing material may be a planar shape in which fibers are woven to be arranged in one direction and the matrix resin may be attached to the fibrous reinforcing material to form the resin composite material in a flexible sheet shape. In this case, the matrix resin may be also formed in a planar shape to overlap the fibrous reinforcing material, or the matrix resin may be made into a powder state or a particle state to be attached to the fibrous reinforcing material to cover the fibrous reinforcing material.

In the first aspect, the fibrous reinforcing material may be a planar shape in which fibers are woven to be arranged in two directions and the matrix resin may be attached to the fibrous reinforcing material to form a flexible sheet shape. In this way, since the fibrous reinforcing materials are woven to be arranged in two directions, it is possible to improve the strength of the fibrous reinforcing material and the strength of the resin composite material.

In the first aspect, the fibrous reinforcing material may be formed in a linear shape and the matrix resin may be attached to the fibrous reinforcing material to form the resin composite material in a flexible thread shape (or a rope shape). In this case, the matrix resin may be formed in a linear shape to be twisted with the fibrous reinforcing material, or the matrix resin may be made into a powder state or a particle state to be attached to the fibrous reinforcing material to cover the fibrous reinforcing material.

In the first aspect, the fibrous reinforcing material and the matrix resin may be formed in a linear shape and the fibrous reinforcing material and the matrix resin may be combined with each other to form the resin composite material in a flexible thread shape.

In the first aspect, the fibrous reinforcing material and the matrix resin may be formed in a linear shape and the fibrous reinforcing material and the matrix resin may be knitted to each other to form the resin composite material in a flexible woven fabric shape. In this case, the fibrous reinforcing material and the matrix resin may be formed in band shapes to be knitted to each other.

In this way, since the resin composite material is formed in a sheet shape, a thread shape, a rope shape, or a woven fabric shape, it is possible to mold the molded resin article having various shapes by appropriately selecting the resin composite material. In the resin composite material, since the metal nanomaterial is included in the matrix resin, by irradiating the resin composite material with electromagnetic waves, resin composite material is thermally cured in a molded form.

According to the resin composite material having the shape, the resin composite material can be laminated using a known lamination method, that is, a lamination method which is manually performed or a lamination method which is performed by an automatic laminating machine.

According to a second aspect of the present invention, there is provided a curing method of a resin composite material, including: a lamination step of laminating the resin composite material according to the first aspect on the molding tool; an electromagnetic wave irradiation step of irradiating the resin composite material laminated on the molding tool with electromagnetic waves to heat the resin composite material; and a pressurization step of pressurizing the surface of the heated resin composite material.

In the resin composite material of the first aspect, since the metal nanomaterial which absorbs electromagnetic waves and self-heats is included in the matrix resin, the resin composite material is self-heated and softened by being irradiated with the electromagnetic waves.

In a case where the matrix resin is a thermosetting resin, a curing reaction is generated by pressurization in this state, and the resin composite material is cured. Meanwhile, in a case where the matrix resin is a thermoplastic resin, the resin composite material is cured by cooling the thermoplastic resin.

Accordingly, in the curing method according to the second aspect, by laminating the resin composite material on the molding tool in the lamination step, irradiating the resin composite material with the electromagnetic waves in the electromagnetic wave irradiation step, and pressurizing the surface of the resin composite material in the pressurization step, it is possible to mold the resin composite material, and it is possible to cure the matrix resin. Accordingly, a heater capable of accommodating all laminated resin composite materials is not required, and it is possible to increase the temperatures of all laminated resin composite materials to thermally cure the resin composite materials.

In the second aspect, the lamination step may be performed a plurality of times, and the electromagnetic wave irradiation step may be performed for each lamination step.

According to this curing method, the resin composite material is irradiated with the electromagnetic waves each time the resin composite material is laminated once. That is, the lamination and the heating of the resin composition material are alternately repeated. Accordingly, it is possible to reliably cure each of the laminated resin composite materials.

According to a third aspect of the present invention, there is provided a molded resin article which is manufactured by the curing method of a resin composite material according to the second aspect. Accordingly, manufacturing costs of the molded resin article are inexpensive.

### Advantageous Effects of Invention

As described above, according to the resin composite material and the curing method of the present invention, it is possible to simplify equipment for heating a thermosetting resin or a thermoplastic resin and reduce manufacturing costs of the molded resin article by saving energy. In addition, the manufacturing costs of the molded resin article according to the present invention are inexpensive.

### BRIEF DESCRIPTION OF DRAWINGS

FIG. 1A shows a first embodiment of the present invention and is a longitudinal sectional view of an uncured prepreg formed in a sheet shape.

FIG. 1B shows the first embodiment of the present invention and is a longitudinal sectional view of the uncured prepreg formed in a sheet shape.

FIG. 1C shows the first embodiment of the present invention and is a longitudinal sectional view of the uncured prepreg formed in a sheet shape.

FIG. 1D shows the first embodiment of the present invention and is a longitudinal sectional view of the uncured prepreg formed in a sheet shape.

FIG. 1E shows the first embodiment of the present invention and is a longitudinal sectional view of the uncured prepreg formed in a sheet shape.

FIG. 1F is a longitudinal section view of the prepreg after molding.

FIG. 2 is a SEM image showing an example of nanofibers.

FIG. 3 is a SEM image showing an example of nanocoils.

FIG. 4 is an enlarged SEM image of the nanocoils.

FIG. 5 is a flowchart showing a curing method according to the present invention.

FIG. 6 is a view showing a state where an uncured prepreg is laminated on a molding tool.

FIG. 7 is a view showing a state where the prepreg is enclosed along with the molding tool by a vacuum bag.

FIG. 8 is a schematic view for explaining an electromagnetic wave irradiation method by an electromagnetic wave irradiation chamber.

FIG. 9 is a schematic view for explaining an electromagnetic wave irradiation method by an electromagnetic wave irradiator.

FIG. 10A shows a second embodiment of the present invention and is a longitudinal sectional view of an uncured prepreg formed in a thread shape.

FIG. 10B shows the second embodiment of the present invention and is a longitudinal sectional view of the uncured prepreg formed in a thread shape.

FIG. 100 shows the second embodiment of the present invention and is a longitudinal sectional view of an uncured prepreg formed in a woven fabric shape.

### DESCRIPTION OF EMBODIMENTS

Hereinafter, embodiments of the present invention will be described with reference to the drawings.

### First Embodiment

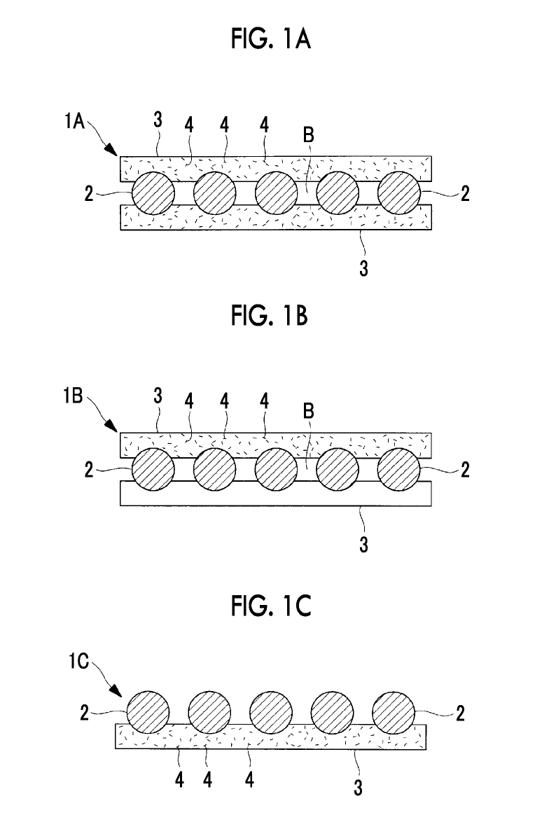

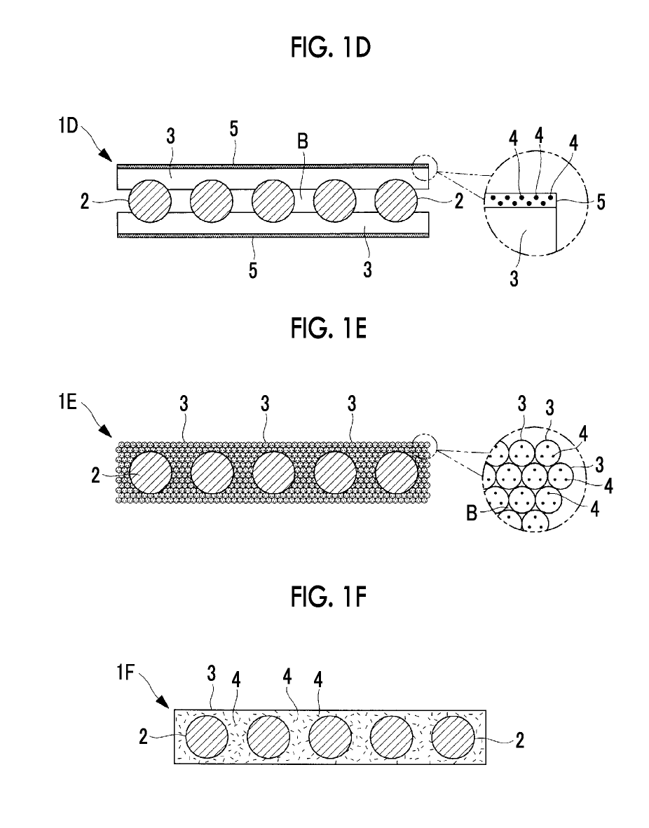

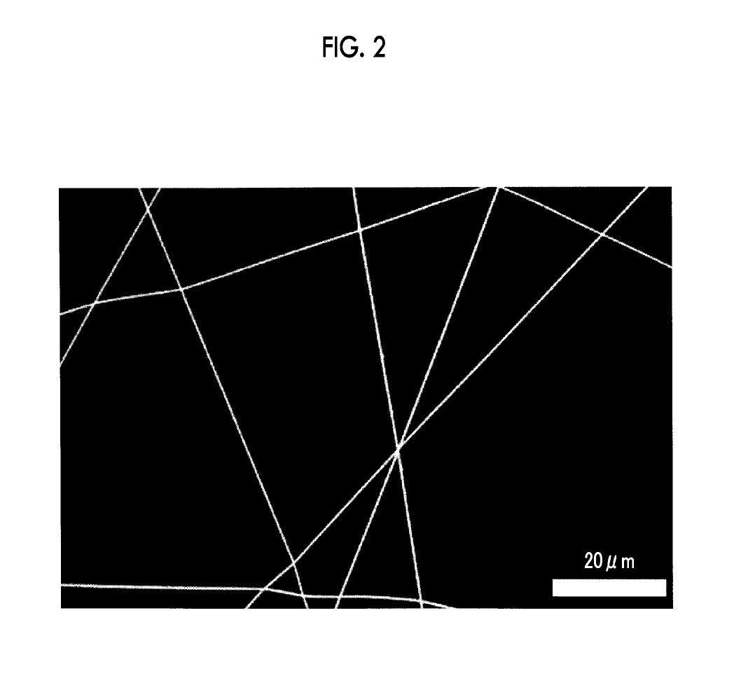

FIGS. 1A to 1E are longitudinal sectional views showing each aspect of an uncured prepreg (resin composite material) according to a first embodiment of the present invention. As is well known, each of prepregs 1A to 1E is a flexible intermediate molding material which is formed in a flexible sheet shape obtained by attaching thermosetting or thermoplastic matrix resins 3 to a mesh-shaped fibrous reinforcing material 2 such as glass fibers or carbon fibers to be semi-integrated.

For example, the material of the matrix resin 3, there is polyether ether ketone (PEEK), polyethylene terephthalate (PET), polybutylene terephthalate (PBT), nylon 6 (PA6), nylon 66 (PA66), polyphenylene sulfide (PPS), polyetherimide (PEI), polyether ketone ketone (PEKK), or the like.

Metal nanomaterials 4 which absorb electromagnetic waves and self-heat are added to the matrix resin 3. Each of the “metal nanomaterial” is a metal material in which a two-dimensional size or three-dimensional size is nanoscale (one to several hundred nm). Specifically, the metal nanomaterials 4 are nanofibers (cross-sectional diameters are nanoscale), nanocoils (cross-sectional diameters are nanoscale and shapes in a longitudinal direction are formed in coil shapes), nanoparticles (particle sizes are nanoscale), nanotubes (hollow fibers having nanoscale in cross-sectional diameters). Particularly, since the nanocoils or the nanofibers have high electromagnetic wave absorption efficiency, the nanocoils or the nanofibers are preferable.

The materials of the metal nanomaterials 4 are not particularly limited, and preferably, the material of each of the metal nanomaterials is a metal which has high electromagnetic wave absorption efficiency in frequencies of emitted electromagnetic waves. Specifically, the material of the metal nanomaterial is platinum (Pt), gold (Au), nickel (Ni), copper (Cu), or the like. In a forming process of the nanocoils or nanofibers, a metal is oxidized. Platinum or gold is not easily oxidized, and even in a case where the platinum or gold is oxidized, since the platinum or gold is a material having conductivity, the platinum or gold is optimal as a nanomaterial.

In a case where an addition amount of the metal nanomaterials 4 with respect to the matrix resin 3 is large, there is a concern that cracks occur when each of the prepregs 1A to 1E is used as a molded resin article. Accordingly, the addition amount of the metal nanomaterials 4 with respect to the matrix resin 3 is 50 μg/cm² or less, preferably 10 μg/cm² or less, and more preferably 2 μg/cm² or less in terms of a weight ratio per unit area. Since the above-described nanomaterials have high electromagnetic wave absorption efficiency, even when the addition amounts thereof are small, it is possible to obtain large heating value.

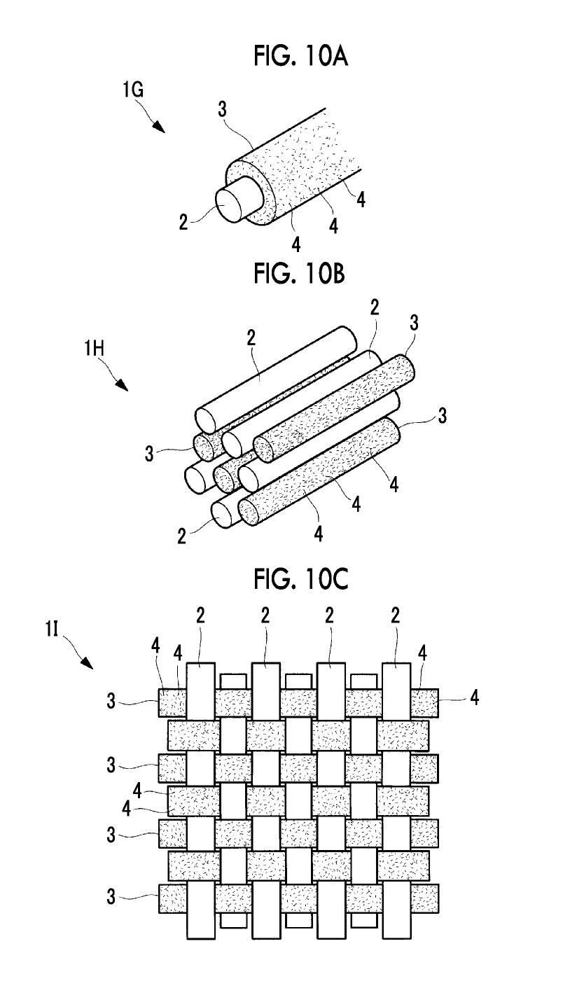

For example, the prepreg 1A shown in FIG. 1A, sheet-shaped matrix resins 3 are attached to both surfaces of the sheet-shaped fibrous reinforcing materials 2, and metal nanomaterials 4 are added to both of two matrix resins 3. As the prepreg 1B shown in FIG. 1B, the metal nanomaterials 4 may be added to only one matrix resin 3. In addition, as the prepreg 1C shown in FIG. 10, the sheet-shaped matrix resin 3 to which the metal nanomaterials 4 are added may be provided on only one surface of the fibrous reinforcing material 2.

In the prepreg 1D shown in FIG. 1D, sheet-shaped matrix resins 3 to which the metal nanomaterials 4 are not added are attached to both surfaces of the sheet-shaped fibrous reinforcing material 2. In addition, thin resin sheets 5 which are formed of the resin materials similar to those of the matrix resin 3 and to which the metal nanomaterials 4 are added are bonded to both surfaces (or one surface) of the prepreg 1D. According to this structure, it is possible to easily change the existing prepreg to which the metal nanomaterials 4 are not added to a prepreg to which the metal nanomaterials 4 are added.

In the prepreg 1E shown in FIG. 1E, matrix resins 3 which are powdery shapes, particulate shapes, linear shapes, fibrous shapes, or the like containing metal nanomaterials 4 are attached to cover the sheet-shaped fibrous reinforcing material 2. In this case, particles of the matrix resins 3 which contain the metal nanomaterials 4 and particles of the matrix resins 3 which do not contain the metal nanomaterials 4 may be mixed with each other.

All the prepregs 1A to 1E shown in FIGS. 1A to 1E contain bubbles B, the bubbles B are extracted by pressurization during molding, and the prepregs 1A to 1E have longitudinal cross sections shown in FIGS. 1F.

For example, metal nanofibers are manufactured using an electro-spinning method.

The metal acetate is dissolved in a polymer solution (for example, polyvinyl alcohol aqueous solution) the obtained solution is sprayed onto the substrate by the electro-spinning method to form nanofibers containing the metal. The obtained nanofibers are heat-treated in a reducing atmosphere to obtain the metal nanofibers (refer to FIG. 2).

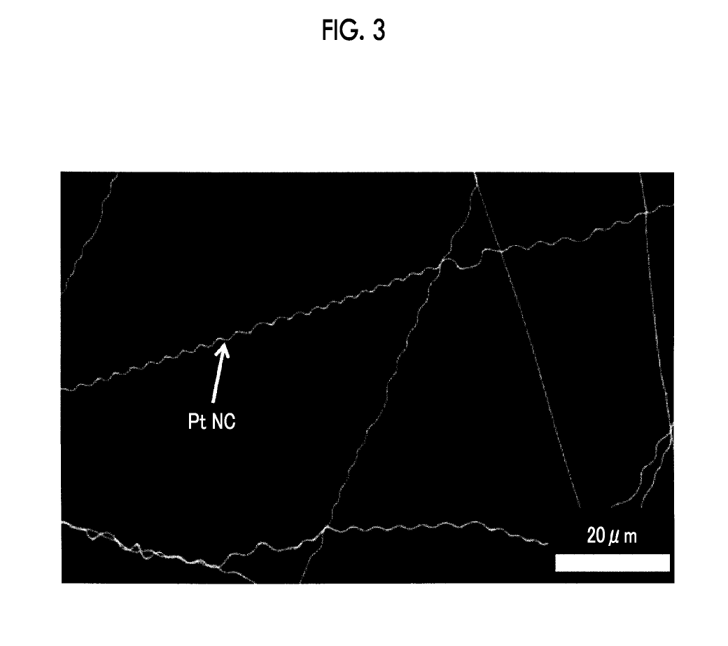

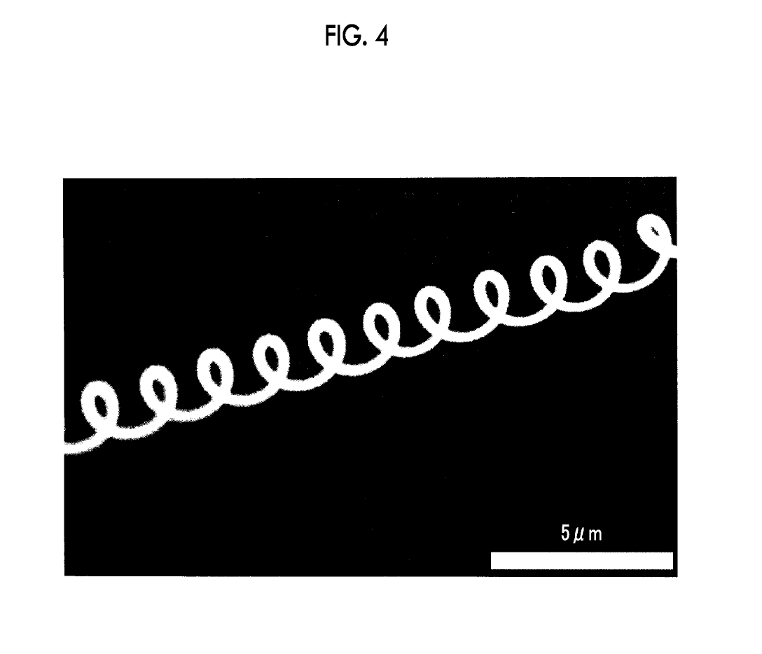

Metal nanocoils are obtained by setting nanofibers manufactured using an electro-spinning method as core portions and forming metal films on the surfaces of the nanofibers. In this case, the core portions may be metal materials or may be polymer materials. The nanocoils may be solid or hollow. As a method for forming hollow nanocoils, there is a method of forming metal films using the core portions of the polymer materials, and thereafter, performing heat treatment on the metal films to evaporate the polymer materials (refer to FIGS. 3 and 4).

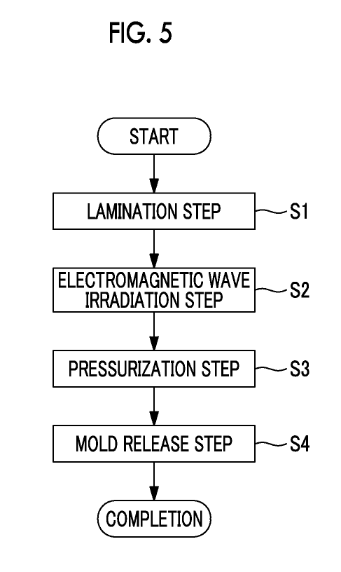

Curing methods of the sheet-shaped prepregs 1A to 1E are performed as follows. In addition, FIG. 5 is a flowchart showing the curing methods (steps) of the prepregs 1A to 1E.

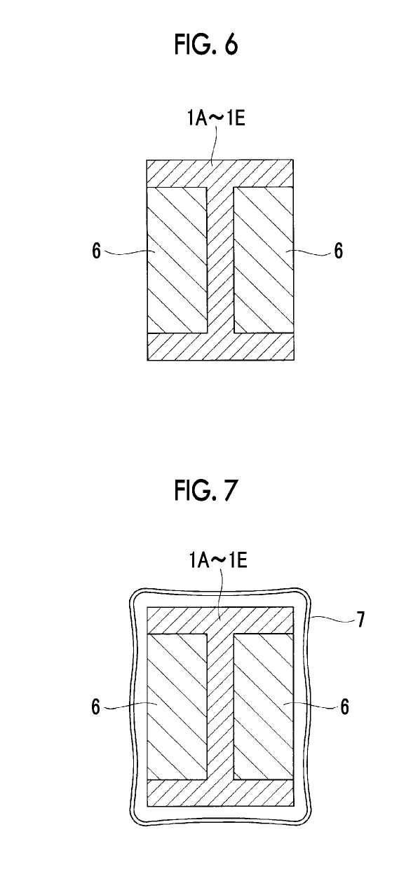

First, as shown in FIG. 6, each of the uncured prepregs 1A to 1E is laminated (placed, wound, or the like) on a molding tool 6, jig, or the like to be molded into a predetermined shape (lamination step S1).

Next, as shown in FIG. 7, each of the prepreg 1A to 1E is enclosed by a vacuum bag 7 along with the molding tool (jig) 6. The steps until this are similar to those of the general curing method.

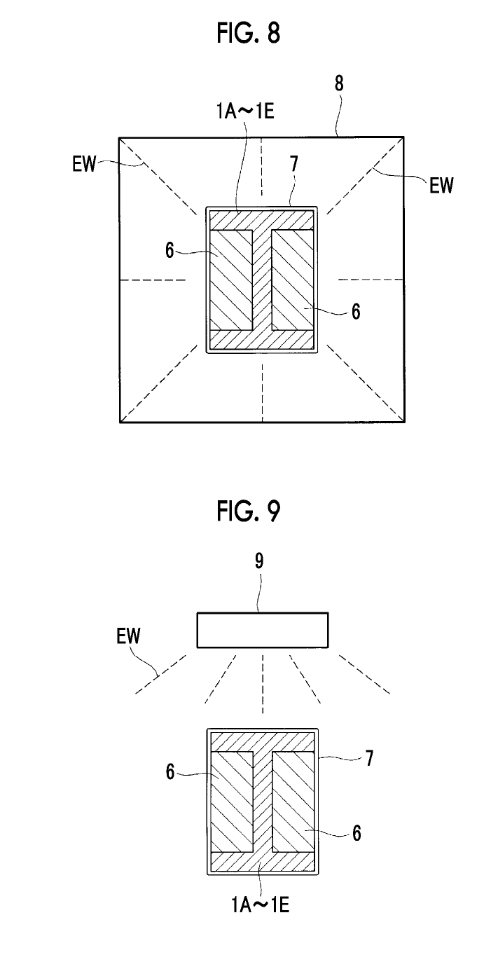

Next, as shown in FIG. 8, each of the prepregs 1A to 1E is irradiated with electromagnetic waves EW (electromagnetic wave irradiation step S2). The frequencies of the electromagnetic waves EW are not limited. However, for example, preferably, the electromagnetic waves EW are electromagnetic waves which do not require special managements unlike X-rays which requires special managements. In addition, preferably, the electromagnetic waves EW are electromagnetic waves having frequencies in which frequency absorption efficiency is high with respect to the metal configuring the metal nanomaterials 4. Considering the above, preferably, short waves (HF, 3 MHz to 30 MHz), ultrashort waves (VHF, 30 MHz to 300 MHz), and microwaves (300 MHz to 3 GHz) are emitted. Specifically, electromagnetic waves of an ISM band can be used. The molding tool (jig) 6, the vacuum bag 7, or the like is required to be formed of a material through which electromagnetic waves EV can pass.

As the irradiation method of the electromagnetic waves EW, in a state where the prepregs 1A to 1E accommodated in the vacuum bag 7, the prepregs 1A to 1E may be accommodated in an electromagnetic wave irradiation chamber 9 so as to be irradiated with the electromagnetic waves EW, or as shown in FIG. 9, an electromagnetic wave irradiator 8 may be installed around the prepregs 1A to 1E to irradiate the prepregs 1A to 1E with electromagnetic waves EW. However, other methods may be used, and the irradiation method of the electromagnetic waves EW is not particularly limited. In a case where the electromagnetic wave irradiator 9 shown in FIG. 9 is used, preferably, each of the prepregs 1A to 1E can be not only entirely irradiated with the electromagnetic waves EW but also locally irradiated with the electromagnetic waves EW.

If the prepreg 1A to 1E are irradiated with the electromagnetic waves EW, metal nanomaterials 4 added to the matrix resins 3 shown in FIGS. 1A to E absorb the electromagnetic waves EW and self-heat. This heat is transmitted to the matrix resins 3 and the matrix resins 3 are softened and melted.

Next, the vacuum bag 7 is evacuated to increase adhesion of the molding tool (jig) 6 with respect to each of the prepregs 1A to 1E. In this case, since a negative pressure can be applied to the vacuum bag 7, each of the prepreg 1A to 1E is pressurized in a thickness direction thereof, and bubbles B included in each of the prepregs 1A to 1E are extracted by the pressure (pressurization step S3).

In a case where the matrix resin 3 of each of the prepregs 1A to 1E is a thermosetting resin, a curing reaction is generated by the pressurization of each of the heated prepregs 1A to 1E, and each of the prepregs 1A to 1E is cured. In a case where the matrix resin 3 is a thermoplastic resin, if the irradiation of the electromagnetic waves EW is completed, the matrix resin 3 is cooled to be cured, and each of the prepregs 1A to 1E is cured.

In any of the above cases, the cross section of each of the prepregs 1A to 1E has the longitudinal cross section shown in FIG. 1F. An irradiation amount and a curing time of the electromagnetic waves EW are appropriately set such that the matrix resins 3 are softened or melted to come into close-contact with the molding tool 6, the bubbles B are extracted, and the shape of the molded resin article is maintained in a state where the matrix resins 3 do not flow out from the fibrous reinforcing materials 2.

In general, the lamination step S1 is performed a plurality of times. That is, in each of the sheet-shaped prepregs 1A to 1E, a plurality of prepregs are laminated and the thickness of the molded resin article is secured. In a case where the lamination steps S1 is performed a plurality of times, preferably, the electromagnetic wave irradiation step S2 is performed for each lamination step S1. Alternatively, the electromagnetic wave irradiation step S2 may be performed once each time the lamination step S1 is performed two or three times.

If each of the prepregs 1A to 1E is cured by the irradiation of the electromagnetic waves EW and the pressurization and the molded resin article is formed, the formed molded resin article is extracted from the vacuum bag 7 to be separated from the molding tool (jig) 6 or the like, and the molded resin article is completed (mold release step S4).

According to the prepregs 1A to 1E and the curing methods thereof, each of the prepregs 1A to 1E is irradiated with the electromagnetic waves EW, and thus, the metal nanomaterials 4 added to the matrix resins 3 absorb the electromagnetic waves EW and self-heat. This heat is transmitted to the matrix resins 3 and the matrix resins 3 which are thermosetting or thermoplastic are cured.

Accordingly, unlike the related art, it is not necessary to accommodate the prepregs 1A to 1E to be cured in a storage type heater such as an autoclave and the storage type heater is not required. Therefore, it is possible to greatly simplify the heating equipment and reduce the manufacturing costs of the molded resin article.

In addition, since only the matrix resins 3 are heated by the irradiation of the electromagnetic waves EW, unlike the heater of the related art, energy for heating all portions including the molding tool, the jig, or the like is not required. Accordingly, it is possible to save energy. Therefore, it is possible to reduce the manufacturing costs of the molded resin article.

In addition, since it is possible to locally heat each of the prepregs 1A to 1E by limiting the irradiation ranges of the electromagnetic waves EW, by locally heating the molded resin article after curing the entire molded resin article, an addition can be provided or additional molding or additional processing can be performed.

Each of the prepregs 1A to 1E which are formed in sheet shapes can be laminated by a known lamination method, that is, a lamination method which is manually performed or a lamination method which is performed by an automatic laminating machine.

As described above, if the electromagnetic wave irradiation step S2 is performed every time the laminating step S1 is performed a plurality of times, the electromagnetic waves EW are emitted a plurality of times while the prepregs 1A to 1E are laminated and after the prepregs 1A to 1E are laminated. That is, the lamination and the heating of the prepregs 1A to 1E are alternately repeated. Accordingly, it is possible to reliably cure each of the laminated prepregs 1A to 1E.

In a case where the metal nanomaterials 4 are nanofibers or nanocoils, since the metal nanomaterials 4 are formed in thin metal wire shapes which are oriented in many directions, particularly, the electromagnetic wave absorption efficiency becomes high. Accordingly, it is possible to rapidly increase the temperatures of the matrix resins 3.

In addition, since it is possible to decrease the addition amount of the metal nanomaterials 4, it is possible to decrease occurrence of cracks in the matrix resin 3 and prevent strength of the resin composite material from being decreased.

By selecting the frequencies of the electromagnetic waves EW for allowing the metal nanomaterials 4 to self-heat from the range of 3 MHz to 3 GHz, it is possible to the absorption efficiency of the electromagnetic waves EW. In addition, since the frequency range is an electromagnetic wave frequency band which does not require a special management, it is possible to emit the electromagnetic waves by a simple device and it is possible to increase a degree of freedom of a place of construction, or the like.

Since the material of the metal nanomaterial 4 is platinum (Pt) or gold (Au), even when a manufacturing process of the metal nanomaterial 4 is performed under an oxidizing atmosphere, the platinum or the gold is not easily oxidized, and since an oxide has conductivity, it is possible to manufacture the metal nanomaterials 4 having high electromagnetic wave absorption efficiency.

By setting the addition amount of the metal nanomaterials 4 with respect to the matrix resins 3 to 50 μg/cm² or less, preferably 10 μg/cm² or less, and more preferably 2 μg/cm² or less in terms of a weight ratio per unit area, self-heating properties sufficient for performing the heat curing are applied to the matrix resins 3, it is possible to prevent occurrence of cracks or the like generated due to the excessive addition amount of the metal nanomaterials 4, and it is possible to prevent strength of the resin composite material from being decreased.

### Second Embodiment

FIGS. 10A to 1C are views showing uncured prepregs which are formed in shapes different from a sheet shape according to a second embodiment of the present invention. Similarly to the prepregs 1A to 1E of the first embodiment, each of prepregs 1G to 1I is a flexible intermediate molding material which is formed by attaching the thermosetting or thermoplastic matrix resin 3 to the fibrous reinforcing material 2 such as glass fibers or carbon fibers to be semi-integrated.

In the prepreg 1G shown in FIG. 10A, the fibrous reinforcing material 2 is formed in a linear shape, the matrix resin 3 is attached around the fibrous reinforcing material 2, and a flexible thread shape (or rope shape) is formed.

In this case, the matrix resin 3 may be made into a powder state to cover the fibrous reinforcing material 2, or may be made into a gel state or a semi-liquid state to be applied to the fibrous reinforcing material 2.

The properties or the characteristics of the metal nanomaterials 4 added to the matrix resin 3 are similar to those of the first embodiment.

In this way, the prepreg 1G formed in a flexible thread shape or a rope shape is wound on the molding tool, the jig, or the like of the molded resin article, and the prepreg G can be laminated on even a complicated curved surface or protrusion-shaped surface without difficulty. In addition, the application of the prepreg G is not limited to the surface, and the prepreg G easily fills a recessed portion, a hole, or the like. Accordingly, it is possible to improve moldability of the molded resin article.

The prepreg 1H shown in FIG. 10B is a formed in a flexible thread shape (commingling material shape) by combining the fibrous reinforcing materials 2 and the matrix resins 3 formed in linear shapes. The properties or the characteristics of the metal nanomaterials 4 added to the matrix resins 3 are similar to those of the first embodiment.

Similarly to the thread (string) shaped prepreg 1G shown in FIG. 10A, the prepreg 1H can be wound around the molding tool, the jig, or the like to be laminated and is suitable for being laminated on a complicated curved surface or the like.

Particularly, in the prepreg 1H, since the matrix resins 3 are knitted inside the fibrous reinforcing materials 2, the prepreg 1H is heated and the knitted matrix resins 3 are melted and cured at the same time.

For this reason, it is not necessary to laminate sheet-like resins, it is easier to handle than the prepreg in which the fibrous reinforcing materials 2 are impregnated into the matrix resins 3, and the lamination process can be greatly shortened.

In the prepreg 1I shown in FIG. 10C, the fibrous reinforcing materials 2 and the matrix resins 3 formed in linear shapes are knitted in cross shapes to be formed in a flexible woven fabric shape. The properties or the characteristics of the metal nanomaterials 4 added to the matrix resins 3 are similar to those of the first embodiment. The fibrous reinforcing materials 2 and the matrix resins 3 may be knitted to be formed in band shapes.

Similarly to the prepreg 1H shown in FIG. 10B, even in the case of the prepreg 1I, since the matrix resins 3 are knitted inside the fibrous reinforcing materials 2, the prepreg 1I is heated and the knitted matrix resins 3 are melted and cured at the same time. Accordingly, it is not necessary to laminate sheet-like resins and the lamination process can be greatly shortened.

The prepregs 1G, 1H, and 1I are formed in a thread shape (rope shape) and a woven fabric shape, and along with the sheet-shaped prepregs 1A to 1E in the first embodiment, by appropriately select prepregs according to the shape of the molding tool, the jig, or the like of the molded resin article, it is possible to mold molded resin articles having various shapes. In addition, in the prepregs 1A to 1I, since the metal nanomaterials 4 are included in the matrix resins 3, by irradiating the prepregs with electromagnetic waves, it is possible to cure the prepregs in a molded form.

As described above, according to the resin composite material and the curing method of the present invention, by irradiating the resin composite material with the electromagnetic waves, it is possible to allow the resin composite material to self-heat to cure the resin composite material.

Accordingly, unlike the related art, it is not necessary to accommodate the prepregs in a storage type heater such as an autoclave and the storage type heater is not required. Therefore, it is possible to greatly simplify the heating equipment, save energy and, reduce the manufacturing costs of the molded resin article.

The present is not limited to the above-described embodiments, modifications and improvements can be appropriately applied within a scope which does not depart from the gist of the present invention, and an embodiment to which modifications and improvements are applied is also included in the scope of the present invention.

For example, in the embodiments, the example is described, in which the present invention is applied to the prepreg in which the matrix resin is half-cured. However, the present invention can be applied to a resin composite material in which the matrix resin is in a fluid state.

In the embodiments, the metal nanomaterials 4 are self-heated by irradiating the metal nanomaterials 4 with the electromagnetic waves having a frequency range from 3 MHz to 3 GHz. However, it is confirmed that the metal nanomaterials 4 can be self-heated by applying even an electric field having a frequency lower than the frequency, for example, an electric field of approximately 20 Hz.

In this way, if the metal nanomaterials 4 are self-heated by applying an electric field having a lower frequency than that of the electromagnetic wave, since the configuration for applying the electric field is simpler than the configuration for emitting the electromagnetic waves, it is possible to simplify the heating equipment, which can contribute to reductions in the manufacturing costs of the molded resin article.

### REFERENCE SIGNS LIST

1A to 1I: prepreg (resin composite material)

2: fibrous reinforcing material

3: matrix resin

4: metal nanomaterial

5: resin sheet

6: molding tool (jig)

7: vacuum bag

8: electromagnetic wave irradiation chamber

9: electromagnetic wave irradiator

EW: electromagnetic wave

S1: lamination step

S2: electromagnetic wave irradiation step

1. A resin composite material formed by combining a fibrous reinforcing material and a thermosetting or thermoplastic matrix resin,
wherein a metal nanomaterial which absorbs electromagnetic waves and self-heats is added to the matrix resin.

2. The resin composite material according to claim 1,
wherein the metal nanomaterial is nanofibers or nanocoils.

3. The resin composite material according to claim 1,
wherein frequencies of the electromagnetic waves are 3 MHz to 3 GHz.

4. The resin composite material according to claim 1,
wherein the material of the metal nanomaterial is platinum or gold.

5. The resin composite material according to claim 1,
wherein an addition amount of the metal nanomaterial with respect to the matrix resin is 2 μg/cm² to 50 μg/cm² in terms of a weight ratio per unit area.

6. The resin composite material according to claim 1,
wherein the fibrous reinforcing material is a planar shape in which fibers are woven to be arranged in one direction and the matrix resin is attached to the fibrous reinforcing material to form the resin composite material in a flexible sheet shape.

7. The resin composite material according to claim 1,
wherein the fibrous reinforcing material is a planar shape in which fibers are woven to be arranged in two directions and the matrix resin is attached to the fibrous reinforcing material to form the resin composite material in a flexible sheet shape.

8. The resin composite material according to claim 1,
wherein the fibrous reinforcing material is formed in a linear shape and the matrix resin is attached to the fibrous reinforcing material to form the resin composite material in a flexible thread shape.

9. The resin composite material according to claim 1,
wherein the fibrous reinforcing material and the matrix resin are formed in a linear shape and the fibrous reinforcing material and the matrix resin are combined with each other to form the resin composite material in a flexible thread shape.

10. The resin composite material according to claim 1,
wherein the fibrous reinforcing material and the matrix resin are formed in a linear shape and the fibrous reinforcing material and the matrix resin are knitted to each other to form the resin composite material in a flexible woven fabric shape.

11. A curing method of a resin composite material, comprising:
a lamination step of laminating the resin composite material according to claim 1 on a molding tool;
an electromagnetic wave irradiation step of irradiating the resin composite material laminated on the molding tool with electromagnetic waves to heat the resin composite material; and
a pressurization step of pressurizing the surface of the heated resin composite material.

12. The curing method of a resin composite material according to claim 11,
wherein the lamination step is performed a plurality of times, and the electromagnetic wave irradiation step is performed for each lamination step.

13. A molded resin article which is manufactured by the curing method of a resin composite material according to claim 11.
